(19) United States
(12) Patent Application Publication
(10) Pub. No.: US 2007/0120808 A1
(43) Pub. Date: May 31, 2007

(54) Display unit and portable device provided with the same

(75) Inventors: Masamichi Shimoda, Tokyo (JP); Daisuke Suzuki, Tokyo (JP); Tatsuya Uchikawa, Tokyo (JP)

Correspondence Address: Paul J. Esatto, Jr.;Scully, Scott, Murphy & Presser, 400 Garden City Plaza, Garden City, NY, 11530, US

(73) Assignee: NEC Corporation, Tokyo (JP)

(21) Appl. No.: 11/440,995

(22) Filed: May 25, 2006

(30) Foreign Application Priority Data
May 26, 2005 (JP) 2005-153576

(51) Int. Cl. G09G 3/36

(52) U.S. Cl. 345/102

(57) ABSTRACT

A liquid crystal display unit includes a control section. The control section reads LED electric current data stored in a storage section based on input information to control a backlight drive section, and controls an LCD panel based on the input information and a video signal. The backlight drive section provides a backlight with an electric current according to the LED electric current data. The LED electric current data outputted to the backlight drive section from the control section and image data outputted to the LCD panel from the control section are transmitted via a common signal line.

This application claims priority to prior application JP 2005-153576, the disclosure of which is incorporated herein by reference.

### BACKGROUND OF THE INVENTION

1. Field of the Invention

The present invention relates to a color display unit provided with a plurality of illuminants mutually differing in luminous colors, and a portable device provided with the same.

2. Description of the Related Art

A display unit for displaying a character and an image has widely been mounted on an electronic equipment. FIG. 1 is a block diagram illustrating a conventional liquid crystal display unit. As shown in FIG. 1, a liquid crystal display unit 401 contains an LCD (Liquid Crystal Display) panel 402 for displaying an image. A backlight 403 for providing the LCD panel 402 with a light is provided behind the LCD panel 402. The LCD panel 402 is provided with a display section 404 for displaying the image, a scanning line drive circuit 405 for sequentially scanning a scanning line arranged on the display section 404, and an LCD drive circuit 406 for applying a data signal to a data line arranged on the display section 404. The backlight 403 contains a white LED (Light Emitting Diode) 407 and a light guide plate (not illustrated). The white LED 407 emits a white light upon receiving an electric current signal from outside, while the light guide plate emits the white light in a planar form toward the LCD panel 402. adjustment circuit 208 is comprised of a variable resistor VR2 and a rectifier diode D2, while the adjustment circuit 209 is comprised of a variable resistor VR3 and a rectifier diode D3. By adjusting the variable resistors VR2 and VR3, it is possible to control the emission intensity of the green LED 202 and the blue LED 203, respectively. In this backlight, by adjusting the electric currents being applied to the LEDs 201 through 203 including each color it is possible to adjust the color at the time of displaying the white color.

However, in the backlight as shown in FIG. 2, when it is desired to have set a white color once by adjusting the variable resistors and subsequently to display the white color including a different color, it is necessary to adjust the variable resistors again. Also, when it is desired to get back to the initial color, it is necessary to adjust the variable resistors again. For this reason, there is a problem that the color of the white color display cannot easily be adjusted.

As a technique for solving the problem, other backlight is disclosed in Patent Document 1. FIG. 3 is a block diagram illustrating another backlight. As shown in FIG. 3, the backlight is different from the one as shown in FIG. 2 in the following points. First, the backlight as shown in FIG. 3 is not provided with the adjustment circuits 207 through 209 (refer to FIG. 2). Additionally, a DAC (Digital-Analog Converter) 221 is provided in the drive circuit 204 in addition to the transistor T1 and the fixed resistor R1. An analog output signal of the DAC 221 is inputted into a gate of the transistor T1 via a buffer 224. Similarly, the drive circuit 205 is provided with a DAC 222 and a buffer 225, while the drive circuit 206 is provided with a DAC 223 and a buffer 226.

A microcomputer chip 230 for inputting digital signals to the DACs 221 through 223, respectively is provided, and the microcomputer chip 230 is provided with a storage circuit 230M. Further, photodetectors PD1, PD2, and PD3 for detecting the lights outputted from the LEDs 201, 202 and 203, respectively, are provided and the results of detection of the photodetectors PD1 through PD3 are inputted into the microcomputer chip 230. The configuration other than the described above in this backlight is similar to that of the backlight as shown in FIG. 2.

In this backlight, the photodetectors PD1 through PD3 detect the emission intensities of the LEDs 201 through 203. Based on these results of detection, the microcomputer chip 230 controls the electric currents being applied to the LEDs 201 through 203 with reference to information stored in the memory circuit 230M. Thus, it is possible to easily and accurately adjust the color at the time of displaying the white color.

FIG. 4 is a block diagram illustrating a mobile phone disclosed in Patent Document 2. As shown in FIG. 4, a mobile phone 301 includes an LCD 302 for displaying an image and an LCD backlight for providing the LCD 302 with a light. The LCD backlight 303 includes LEDs (not illustrated) having each color of R, G, and B. The mobile phone 301 also includes a control section 304 for controlling the LCD 302 and the LCD backlight 303.

The control section 304 includes a CPU (Central Processing Unit) 305, an ROM (Read-Only Memory) 306, and an RAM (Random Access Memory) 307, that are connected to the CPU 305. The control section 304 also includes an RGB drive IC (Integrated Circuit) 308 for driving the LCD backlight 303 based on a control signal from the CPU 305, and a peripheral IC 309 connected to the CPU 305. Outside the control section 304, there are provided a keypad 310 for inputting information to the peripheral IC 309, and an external I/O 311 to be used for connection with outside.

In the mobile phone 301, electric current setting values for driving the LEDs having each color of R, G, and B of the LCD backlight 303 are stored in the ROM 306. When a user selects the electric current setting value stored in the ROM 306 by means of operating the keypad 310, the CPU 305 controls the RGB drive IC 308 based on the electric current setting value, and thereby adjusting the color at the time of displaying the LCD backlight 303 in white color. Thus, the user of the mobile phone 301 can easily display a desired color of the white color on the LCD 302.

The above-mentioned conventional technique, however, has problems as described hereinbelow.

The backlight as shown in FIG. 3 requires a number of signal lines for inputting digital signals to the DACs 221 through 223 of the drive circuits 204 through 206. Moreover, although not shown in FIG. 3, the liquid crystal display unit including the backlight is also provided with signal lines for transmitting an LCD image signal and an LCD control signal. For this reason, a circuit area required for arranging the signal lines becomes wide, resulting in an increase in size of the liquid crystal display unit. Moreover, if trying to prevent an increase in size, a narrow-pitch or multilayered circuit board is consequently required, resulting in an increase in cost of the unit.

The mobile phone as shown in FIG. 4 has similar problems. As shown in FIG. 4, electric current setting value data for the LCD backlight 303 is outputted from the CPU 305 to the RGB drive IC 308. The LCD image signal is also outputted from the CPU 305 to the peripheral IC 309. The electric current setting value data and the LCD image signal require a number of signal lines for transmission. For this reason, the circuit area required for arranging the signal lines becomes wide, resulting in an increase in size and cost of the unit.

### SUMMARY OF THE INVENTION

The present invention is made in view of the above-mentioned problems, and aims to provide a display unit having fewer number of signal lines and a portable device including the same, in a display unit capable of performing color display.

A display unit according to the present invention comprises a plurality of illuminants mutually differing in luminous colors, a drive section for driving the illuminants, a display panel for displaying an image by being illuminated from the illuminants, a control section for controlling the drive section and the display panel. According to an aspect of the present invention, the display unit further comprises a common signal line for transmitting a first signal constituting at least a part of signals that the control section outputs to the drive section, and a second signal constituting at least a part of signals that the control section outputs to the display panel.

In the present invention, transmitting the first signal and the second signal via the common signal line makes it possible to decrease the number of the signal lines.

In the display unit according to the present invention, it may be that the common signal line transmits the first signal and the second signal in a time-division format and that both the first signal and the second signal are arranged within one frame.

Further, it may be that the first signal is electric power data for representing the magnitude of electric power wherein the drive section supplies to each of the illuminants, and that the second signal is image data for representing the image-displayed on the display panel.

In this case, the display unit still further comprises other common signal line for transmitting a third signal constituting at least a part of signals excluding the first signal out of signals that the control section outputs to the drive section and a fourth signal constituting at least a part of signals excluding the second signal out of signals that the control section outputs to the display panel. Thus, the number of the signal lines can be further decreased.

Furthermore, it is desirable that the control section generates the first signal based on input information inputted from outside and thereby adjusts an emission intensity of the each illuminant. Thus, a user can set the emission intensity of each illuminant.

It is desirable that the display unit further comprises a storage section for storing the electric power data and that the control section reads the electric power data from the storage section based on the input information, and thereby generates the first signal. Thus, the emission intensity of each illuminant can be easily adjusted.

It may be that the control section adjusts a color of white color display of the display panel by adjusting the emission intensity. In this case, the input information may relate to a color temperature of the white color display, and the input information may relate to the emission intensity of the each illuminant. Alternatively, the input information may relate to the emission intensity of the each illuminant. Thus, it is possible to correspond to preferences of colors that are different depending on regions.

It may be that the control section adjusts the brightness of the display panel by adjusting said emission intensity.

According to another aspect of the present invention, the display unit may comprise a common signal line for transmitting a first signal which constitutes at least a part of signals that said control section outputs to said drive section and which is electric power data for representing the magnitude of electric power that said drive section supplies to each of said illuminants, and a fourth signal which constitutes at least a part of signals that said control section outputs to said display panel and which is a control signal for controlling a drive circuit provided in said display panel.

According to still another aspect of the present invention, a portable device comprising the above-mentioned display unit is provided.

According to yet another aspect of the present invention, a portable device comprising the above-mentioned display unit and a GPS device is provided. In this case, the portable device obtains information for representing the region through the GPS device.

According to yet another aspect of the present invention, a portable device comprising the above-mentioned display unit is provided. The portable device obtains information for representing the region from international roaming information.

According to the present invention, in the display unit capable of performing the color display, it is possible to decrease the number of the signal lines by transmitting the first and second signals via the common signal line.

### BRIEF DESCRIPTION OF THE DRAWINGS

FIG. 1 is a block diagram illustrating a conventional liquid crystal display unit;

FIG. 2 is a circuit diagram illustrating a backlight of a liquid crystal display unit as disclosed in Patent Document 1;

FIG. 3 is a block diagram illustrating other backlight as disclosed in Patent Document 1;

FIG. 4 is a block diagram illustrating a mobile phone as disclosed in Patent Document 2;

FIG. 5 is a block diagram illustrating a liquid crystal display unit according to a first embodiment of the present invention;

FIG. 6 is a block diagram illustrating a configuration of a control section as shown in FIG. 5;

FIG. 7 is a diagram illustrating a composite data signal outputted from the control section as shown in FIG. 5;

FIG. 8 is a block diagram illustrating a configuration of a backlight drive section as shown in FIG. 5;

FIG. 9 is a block diagram illustrating a configuration of an LCD module as shown in FIG. 5;

FIG. 10 is a flowchart illustrating the operation when a user sets a desired color;

FIG. 11 is a perspective view illustrating an example of a setup screen in case of setting the color by selecting a color temperature;

FIG. 12 is a perspective view illustrating an example of the setup screen in case of setting the color by adjusting the intensity of each color;

FIG. 13 is a perspective view illustrating an example of the setup screen in case of setting the brightness;

FIG. 14 is a block diagram illustrating a liquid crystal display unit according to a third embodiment of the present invention;

FIG. 15 is a block diagram illustrating a configuration of an LCD module as shown in FIG. 14;

FIG. 16 is a perspective view illustrating the LCD module and a flexible cable as shown in FIG. 14; and

FIG. 17 is a perspective view illustrating an example of the LCD module and the flexible cable for the purpose of comparison with the present invention.

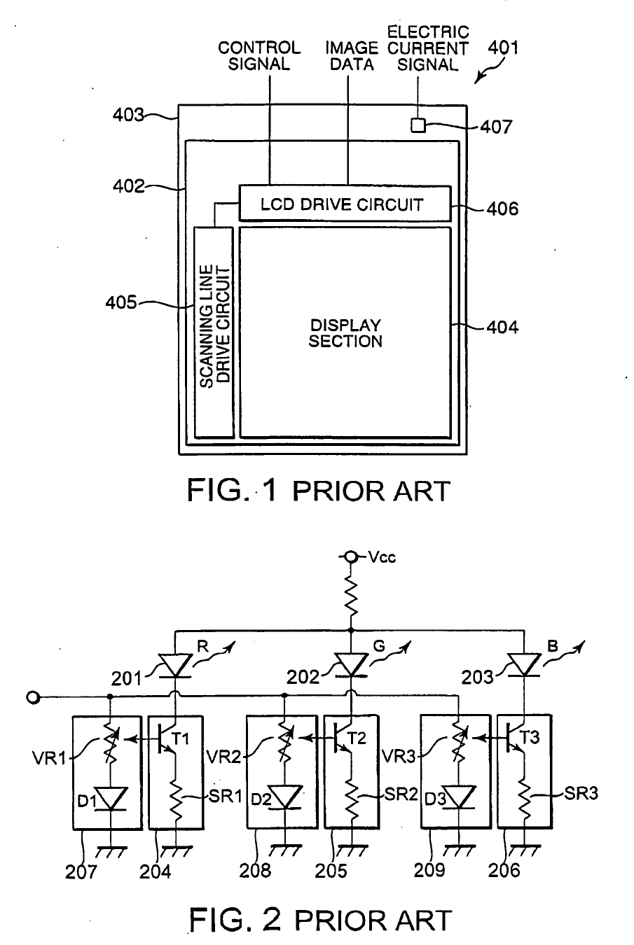

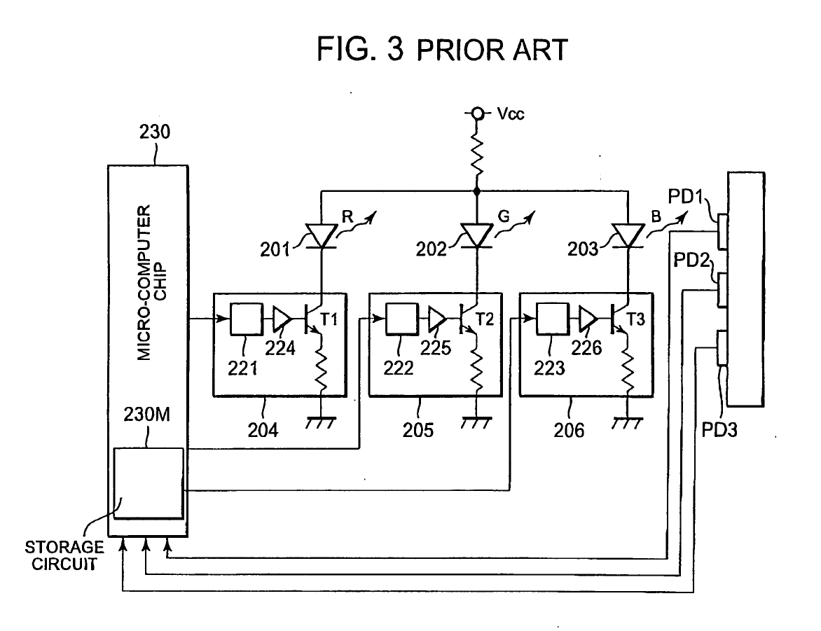

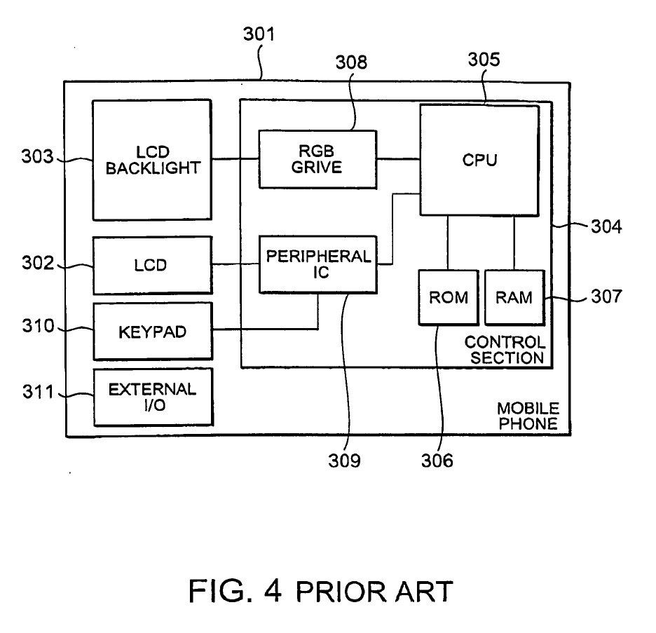

### DESCRIPTION OF THE PREFERRED EMBODIMENTS

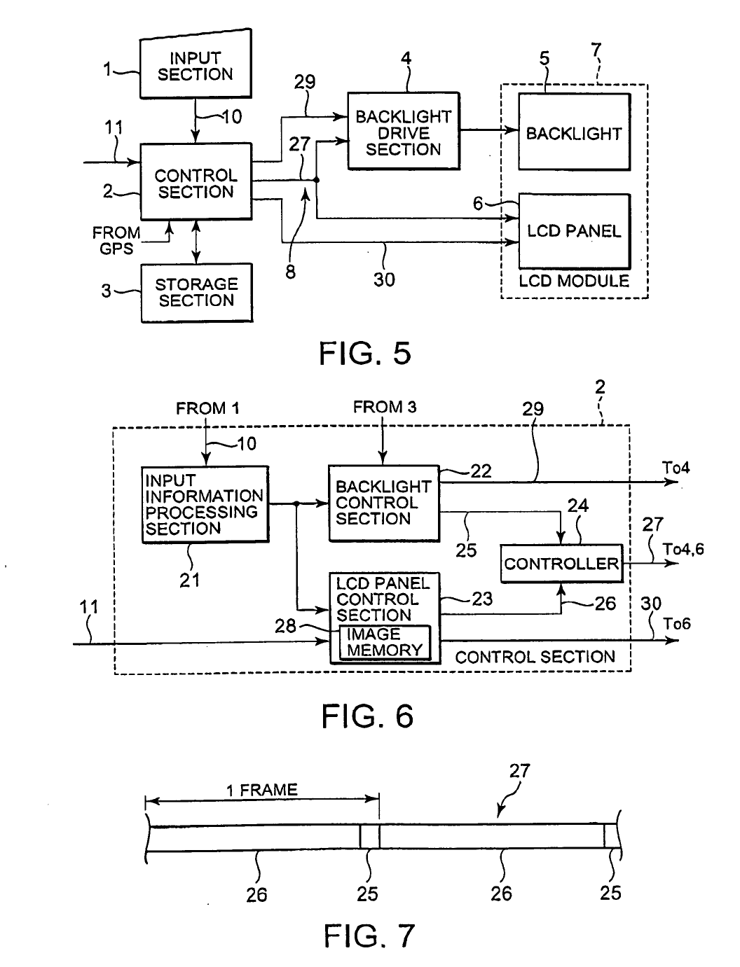

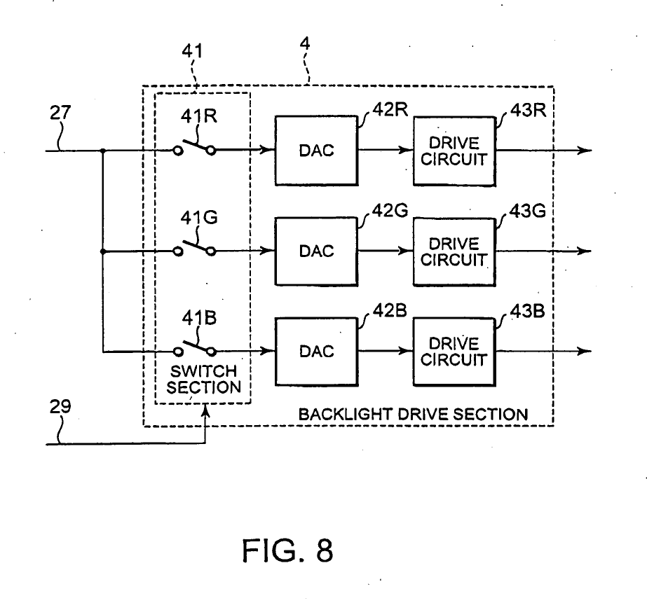

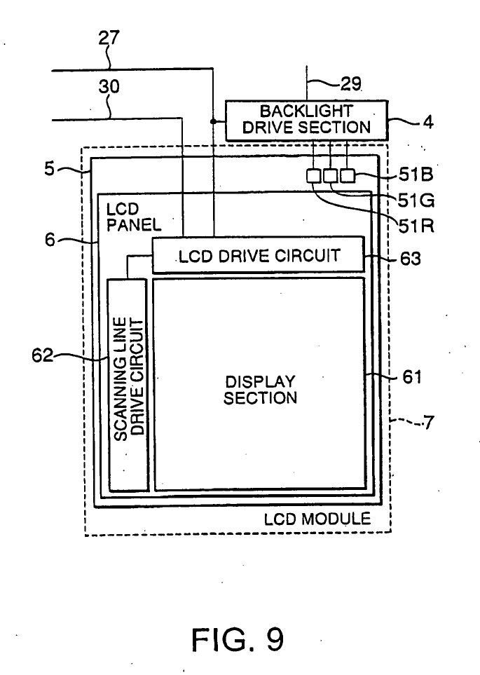

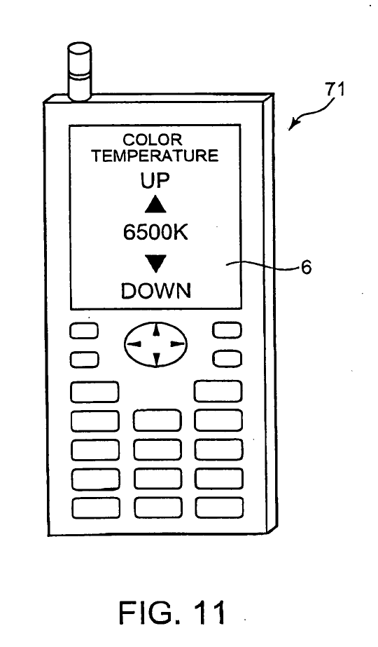

Hereinafter, embodiments of the present invention will be specifically described with reference to the drawings. First, a first embodiment of the present invention will now be described. FIG. 5 is a block diagram illustrating a liquid crystal display unit according to the first embodiment, while FIG. 6 is a block diagram illustrating a control section shown in FIG. 5. FIG. 7 is a diagram illustrating a composite data signal outputted from the control section as shown in FIG. 5 in time series, while FIG. 8 is a block diagram illustrating a backlight drive section as shown in FIG. 5. FIG. 9 is a block diagram illustrating an LCD module as shown in FIG. 5. The liquid crystal display unit according to the first embodiment is mounted on a portable device such as a mobile phone 71 (refer to FIG. 11).

As shown in FIG. 5, the liquid crystal display unit according to the first embodiment is generally comprised of five blocks, namely, an input section 1, a control section 2, a storage section 3, a backlight drive section (drive section) 4, and an LCD module 7. The LCD module 7 is comprised of a backlight 5 and an LCD panel 6.

The input section 1 is a circuit for receiving input information 10 from a key (not shown) provided on the portable device and subsequently outputting the input information 10 to the control section 2. The control section 2 reads LED electric current data stored in the storage section 3 based on the input information 10 inputted from the input section 1 to control the backlight drive section 4, and controls the LCD panel 6 based on the input information 10 and a video signal 11. The storage section 3 includes, for example, a memory, and stores, the LED electric current data (or power data) for representing an electric current value of an LED provided in the backlight 5. The LED electric current data is referred to when the control section 2 selects the color of the white color display of the LCD panel 6. The backlight drive section 4 provides the backlight 5 with an electric current according to the LED electric current data. As shown in FIG. 5, a part of a signal (first signal) outputted to the backlight drive section 4 from the control section 2 and a part of a signal (second signal) outputted to the LCD panel 6 from the control section 2 are transmitted via the same signal line (common signal line) 8. The signal line 8 is a composite wire comprised of, for example, eighteen wirings.

Configurations of each block will be hereinbelow described in detail. As shown in FIG. 6, the control section 2 is comprised of an input information processing section 21, a backlight control section 22, an LCD panel control section 23 including an image memory 28 and a controller 24. The input information processing section 21 is a circuit for receiving the input information from the input section 1, and processing the input information 10 to sort to the backlight control section 22 and the LCD panel control section 23. The backlight control section 22, based on the input information 10 inputted from the input information processing section 21, selects the LED electric current data from a table stored in the storage section 3 to output selected LED electric current data 25 to the controller 24, and outputs a selection signal 29 of three sorts, R, G, and B, of DACs (Digital-Analog Converter) as described later, to the backlight drive section 4.

To the LCD panel control section 23, the input information 10 sorted by the input information processing section 21 is inputted, and the video signal 11 is inputted from the outside of the liquid crystal display unit. The LCD panel control section 23 generates image data 26 with RGB having 6 bits each from the video signal 11, or information stored in the image memory 28, and outputs the same to the controller 24 and outputs a control signal 30 to the LCD panel 6. The control signal 30 includes a serial I/F (Interface) signal for performing various settings to an LCD drive circuit (to be described later) provided in the LCD panel, a horizontal synchronizing signal outputted every horizontal scanning period, a vertical synchronizing signal outputted every vertical scanning period, and a clock signal in synchronization with a composite data signal 27 to be described later.

To the controller 24, the LED electric current data 25 with RGB, each color having 6 bits, is inputted from the backlight control section 22, and the image data 26 with RGB, each color having 6 bits, is inputted from the LCD panel control section 23. The controller 24 generates the composite data signal 27 based an the LED electric current data 25 and the image data 26, and outputs the same to both the backlight drive section 4 and the LCD panel 6 (refer to FIG. 15).

The composite data signal 27 is a digital signal with RGB, each color having 6 bits. As shown in FIG. 7, the composite data signal 27 includes the LED electric current data (first signal) 25 and the image data (second signal) 26 in a time-division format during one frame cycle, namely, during a cycle for rewriting one screen of an image. In other words, in the composite data signal 27, the LED electric current data 25 is inserted during the period of time from when output of one screen of the image data 26 in a certain frame was completed to when output of the image data 26 in the next frame is started. Thus, the image data 26 and the LED electric current data 25 can be outputted to both the backlight drive section 4 and the LCD panel 6 without having any effect on the display (refer to FIG. 5). Note herein that, the LED electric current data 25 is outputted every frame in the first embodiment, however, the same can be outputted only at the time of changing the data.

The image data 26 included in the composite data signal 27 is of 18 bits of digital signals, in total, of each color having 6 bits. The digital signals are then transmitted in parallel using eighteen wirings constituting the signal line 8. Namely, placing one bit of a digital signal on one wiring, the 18 bits of digital signals may simultaneously be transmitted. Meanwhile, the LED electric current data 25 included in the composite data signal 27 is also of 18 bits of digital signals, in total, each color having 6 bits. However, the LED electric current data 25 is transmitted using six wirings out of the eighteen wirings constituting the signal line 8. That is, the three colors of data are transmitted every color in a time-division format.

As shown in FIG. 8, the backlight drive section 4 includes a switch section 41. The switch section 41 is comprised of switches 41R, 41G, and 41B corresponding to each color, RGB. The composite data signal 27 outputted from the controller 24 of the control section 2 is inputted into each of one end of the switches 41R, 41G and 41B. On/off of each switch is controlled by the selection signal 29 outputted from the backlight control section 22 of the control section 2. An input terminal of a DAC 42R is connected to the other end of the switch 41R, and a drive circuit 43R is connected to an output terminal of the DAC 42R. Similarly, a DAC 42G and a drive circuit 43G are connected to the other end of the switch 41G in this order, and a DAC 42B and a drive circuit 43B are connected to the other end of the switch 41B to in this order.

The switch section 41 sorts the data of each color of the LED electric current data 25 included in the composite data signal 27 to the DACs 42R, 42G, and 42B. For example, the switch 41R takes out only red color data of the LED electric current data 25 from the composite data signal 27 and outputs the same to the DAC 42R. The DAC 42R converts a digital voltage signal inputted from the switch 41R into an analog voltage signal. The drive circuit 43R converts the analog voltage signal inputted from the DAC 42R into an electric current signal and provide the same to a red LED 51R of the backlight 5 (refer to FIG. 9). The switch 41G, the DAC 42G the drive circuit 43G, the switch 41B, the DAC 42B and the drive circuit 43B, have similar functions, and each of the same deals green color data and blue color data. Since the LED electric current data 25 includes the data of RGB, each color having 6-bits, the DACs can output the electric current with 64 gradations, respectively. Hence, approximately 260,000 series of electric current settings can be made for the whole of RGB. Note herein that, when such detailed electric current settings are not required, the number of bits of the LED electric current data 25 may be reduced.

As shown in FIG. 9, the backlight 5 of the LCD module 7 has three sorts of LEDs, 51R, 51G, and 51B (hereinafter also collectively referred to as LEDs 51) for emitting lights of each color of RGB, and a light guiding plate (not shown) for synthesizing the lights entered from the LEDs 51 and outputting the same to the LCD panel 6 in a planar form.

The LCD panel 6 of the LCD module 7 includes a display section 61. The display section 61 includes a plurality of scanning lines (not shown) extending in a horizontal direction (transverse direction) of a screen and a plurality of data lines (not shown) extending in a vertical direction (longitudinal direction) of the screen, and is comprised of a plurality of pixels provided every nearest point of contact of the scanning line and the data line. The display section 61 is provided with a color filter (not shown). The LCD panel 6 also includes a scanning line drive circuit 62 for sequentially selecting the scanning line for performing a vertical scanning, and an LCD drive circuit 63 connected to the scanning line drive circuit 62 and the data lines. The control signal 30 and the image data 26 among the composite data signal 27 are inputted to the LCD drive circuit 63, and thereby, the LCD drive circuit 63 generates a control signal for controlling the scanning line drive circuit 62, and writes the image data 26 into each pixel of the display section 61 via the data lines. Since the image data 26 is of a signal including data of colors, each having 6 bits, the display section 61 can perform the color display with 260,000 colors.

Next, the operation of the liquid crystal display unit according to the first embodiment configured as explained above will be described with reference to FIGS. 5 through 9.

First, the operation at the time of power activation of the mobile phone will be described. When the power of the mobile phone is activated, the LCD panel control section 23 of the control section 2 as shown in FIG. 6 outputs the control signal 30 to the LCD drive circuit 63 of the LCD panel 6. In other words, the LCD panel control section 23 outputs the serial I/F signal to perform various sorts of settings for activating the LCD drive circuit 63, and also outputs other control signals (the horizontal synchronizing signal, the vertical synchronizing signal, and the data clock signal). The LCD drive circuit 63 generates the control signal for the scanning line drive circuit 62 based on the serial I/F signal, and puts the scanning line drive circuit 62 into operation. Through the above-mentioned operation, the LCD panel 6 enters a wait state for the composite data signal 27. Moreover, the LCD panel control section 23 reads start-up image data stored in the image memory 28, and outputs the same to the controller 24 as the image data 26.

Meanwhile, a table as preliminarily shown in Table 1 is stored in the storage section 3. As shown in Table 1, 6 bits of data representing the LED electric current value of each of RGB every color is stored in the table. For example, the electric current value being applied to the red LED 51R in the color having a color temperature of 6500 K is stored in the storage section 3 as 6 bits of data R3. The backlight control section 22 reads the LED electric current data 25 corresponding to a predetermined color, for example, the LED electric current data 25 having the color temperature of 6500 K from the storage section 3 in the tables as shown in Table 1 and outputs the same to the controller 24.

TABLE 1

| | LED Electric current data | | |
|---|---|---|---|
| Color Temperature | R | G | B |
| . . . | . . . | . . . | . . . |
| 5500K | R1 | G1 | B1 |
| 6000K | R2 | G2 | B2 |
| 6500K | R3 | G3 | B3 |
| 7000K | R4 | G4 | B4 |
| 7500K | R5 | G5 | B5 |
| . . . | . . . | . . . | . . . |

The controller 24 synthesizes the image data 26 for representing the start-up image transmitted from the LCD panel control section 23 and the LED electric current data 25 transmitted from the backlight control section 22 and thereby, generates the composite data signal 27 (refer to FIG. 7). The controller 24 outputs to both the switch section 41 of the backlight drive section 4 and the LCD drive circuit 63 of the LCD panel 6 through the signal line 8. At this time, the image data 26 included in the composite data signal 27 is transmitted in parallel using the eighteen wirings constituting the signal line 8. Meanwhile, the LED electric current data 25 transmits three-color data in a time-division format, using six wirings out of the eighteen wirings constituting the signal line 8.

The LCD drive circuit 63 downloads the image data 26 included in the composite data signal 27. The LCD drive circuit 63 then writes the image data 26 into the data lines in synchronization with the moment when the scanning line drive circuit 62 sequentially selects the scanning line of the display section 61. Thus, the image represented by the image data 26, namely, the start-up image is displayed on the display section 61.

Meanwhile, the backlight control section 22 of the control section 2 outputs the selection signal 29 to the switch section 41 of the backlight drive section 4, and sequentially turns on the switches 41R, 41G, and 41B. Thus, the red color data R3, the green color data G3, and the blue color data B3 of the LED electric current data 25 as shown in Table 1 are taken out from the composite data signal 27 and provided to the DAC 42R, the DAC 42G, and the DAC 42B, respectively. Each of the red color data R3, the green color data G3, and the blue color data B3 is of 6 bits of digital voltage signal, respectively. Subsequently, the DAC 42R converts the red color data R3 into the analog voltage signal, and the drive circuit 43R then converts the analog voltage signal into the analog electric current signal to provide the same to the LED 51R of the backlight 5. Similarly, the DAC 42G converts the green color data G3 into the analog voltage signal, and the drive circuit 43G then converts the same into the analog electric current signal to provide the same to the LED 51G. Moreover, the DAC 42B converts the blue color data B3 into the analog voltage signal, and the drive circuit 43B then converts the same into the analog electric current signal to provide the same to the LED 51B. Thus, receiving the electric current signals after conversion, the LED 51 of the backlight 5 emits light with brightness according to the electric current signals. The light is synthesized and emitted in a planar form, by the light guiding plate, being illuminated to the LCD panel 6. As a result of this, the LCD module 7 sets the white color display to a predetermined color and displays the image.

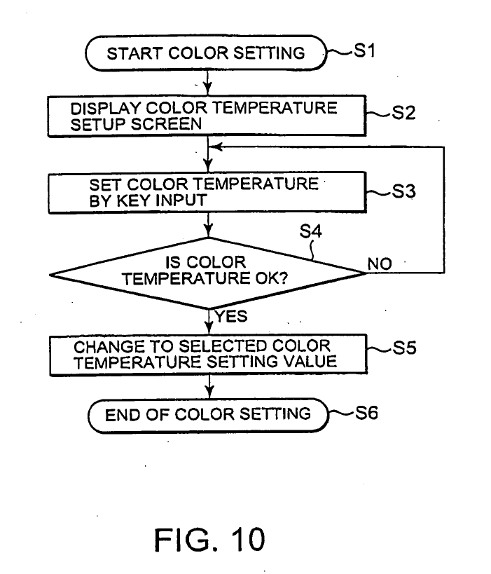

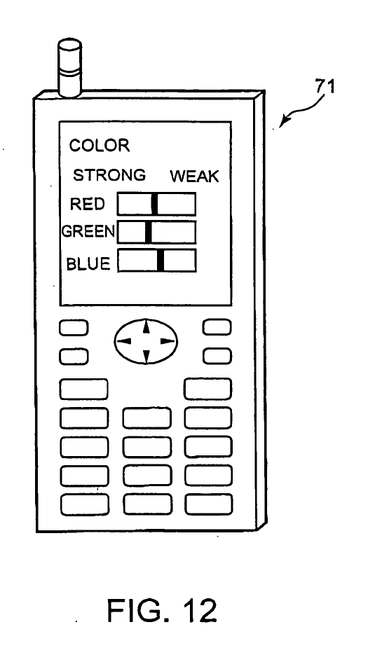

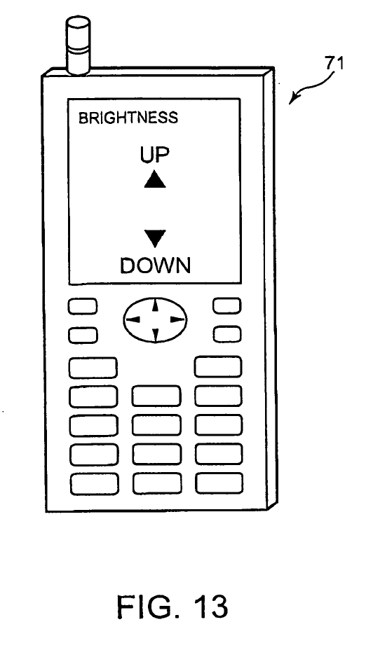

Next, the operation in case that a user sets a desired color will be described. FIG. 10 is a flowchart illustrating the operation in case that a user sets the desired color, while FIG. 11 is a perspective view illustrating the setup screen in case that the color is set by selecting the color temperature. FIG. 12 is a perspective view illustrating a setup screen in case that the color is set by adjusting intensity of each color, while FIG. 13 is a perspective view illustrating the setup screen in case that the brightness thereof is set.

First, at Step S1 in FIG. 10, the user selects a color setting by a key input. Thus, at Step S2, the LCD panel control section 23 of the control section 2 selects the image data 26 for representing the setup screen as shown in FIG. 2011 from the image data stored in the image memory 28, and outputs the same to the controller 24. The controller 24 replaces only the image data 26 in the composite data signal 27, and then outputs the same to the LCD panel 6 as the new composite data signal 27. As a result of this, the display panel 6 of the mobile phone 71 displays the setup screen as shown in FIG. 11. At this time, a background color of the setup screen has been changed into the white color.

Next, at Step S3 in FIG. 10, the user, while watching the setup screen as shown in FIG. 11, selects the color temperature by operating up/down keys so as to obtain the desired color. For example, the user may select 7000 K by increasing the color temperature by one level from 6500 K. The input information 10 inputted by the key input is inputted to the control section 2 via the input section 1. The input information processing section 21 of the control section 2 receives the input information 10, and then sends an instruction to the backlight control section 22 and the LCD panel control section 23.

Based on the instruction, the backlight control section 22 reads the LED electric current data 25 corresponding to the selected color temperature (for example, 7000 K) from the table (refer to Table 1) stored in the storage section 3, and outputs the same to the controller 24. Meanwhile, the LCD panel control section 23 reads, from the image memory 28, the image data of the image indicating the color temperature (for example, 7000 K) that is selected by the user, and outputs the same to the controller 24 as the image data 26. The image is the one in which an indication of “6500 K” in the setup screen as shown in FIG. 11 has been changed to an indication of “7000 K”, for example.

The controller 24 changes the image data 26 and the LED electric current data 25, respectively, and generates the new composite data signal 27 to output the same to the backlight drive section 4 and the LCD panel 6. As a result of this, the color of the background color (white color) of the setup screen displayed on the display section 61 is changed to the color with the selected color temperature.

Next, the process proceeds to Step S4. At Step S4, if the selected color does not meet the color of a user's preference, the process returns to Step S3, and then Steps S3 and S4 are repeated until the color meets that of the user's preference. If the color of the background color of the setup screen meets that of the user's preference, the process proceeds to Step S5. At Step S5, the LED electric current data 25 that the backlight control section 22 reads from the storage section 3 at the time of start-up of the mobile phone is changed to the data set by the user from the data set at the stage of shipping. As a result of this, the user setting of the color is completed as shown at Step 86.

By performing the above-mentioned operation, thereafter, every time the power of the mobile phone is activated, the backlight control section 22 reads, from the storage section 3, the LED electric current data 25 corresponding to the color selected by the user, and the LCD module 7 always displays the white color with the color selected by the user.

The above-mentioned description is about the operation in case that the user sets the color of the white color display by selecting the color temperature. In the liquid crystal display unit according to the first embodiment, however, the user can set the color of the white color display by adjusting the intensity of each color of RGB, respectively. Hereinafter, the operation for this case will be described.

By means of the user's selection of the color setting, the LCD panel control section 23 selects the image data 26 for representing the setup screen as shown in FIG. 12 from the image data stored in the image memory 28, and outputs the same to the controller 24. Thus, the LCD panel 6 of the mobile phone 71 displays the setup screen as shown in FIG. 12. While watching the setup screen, the user individually adjusts the intensity of each color of RGB. For example, if the user desires to intensify R (red), the user slides a bar R toward “high”. Based on this information, the input information processing section 21 of the control section 2 issues an instruction to the backlight control section 22. The backlight control section 22, based on this instruction, reads the new LED electric current data 25 from the storage section 3, and outputs the same to the controller 24. The subsequent operation is the same as the above-mentioned operation at the time of selecting the color temperature. In a manner described above, the color of the white color display can be set.

In addition, in the liquid crystal display unit according to the first embodiment, the brightness of the display may also be changed. Hereinafter, the operation will be described. By means of the user's selection of a brightness setting, the LCD panel control section 23 reads the image data 26 for representing the setup screen shown in FIG. 13 from the image data stored in the image memory 28, and outputs the same. Thus, the LCD panel 6 of the mobile phone 71 displays the setup screen as shown in FIG. 13. While watching the setup screen, the user adjusts the brightness by the key input. In case of changing the brightness, the backlight control section 22 outputs an electric current obtained by multiplying the LED electric current data 25 by a certain gain (coefficient). Thus, the electric current values can be uniformly increased or decreased without changing a relative ratio of the electric current values being applied to the LEDs, 51R, 51G, and 51B. Since the brightness of the LED increases in proportion to the electric current, it is possible to change the brightness by such operation without changing the color of the display. Note herein that, if the brightness of the LED becomes non-linear to the electric current value, the gain according to the non-linear characteristic may be stored in the storage section 3 in advance and the backlight control section 22 may select the gain in accordance with the brightness setting.

When also adjusting the brightness, the background color of the display becomes a white color, and the brightness of a background white color display is changed in accordance with the key input. After a brightness adjustment is completed, the new LED electric current data 25 is set to the backlight control section 22. As a result of this, thereafter, every time the power of the liquid crystal display unit is activated, the new LED electric current data 25 is outputted from the backlight control section 22, and thereby, the LCD module 7 can always display with the brightness selected by the user.

Next, effects according to the first embodiment will be described. In the first embodiment, the storage section 3 stores the LED electric current data corresponding to a plurality of colors. For this reason, when it is desired to change the color of the white color display, it is possible to easily change the color of white color display by reading the LED electric current data stored in the storage section 3.

In addition, in the first embodiment, the controller 24 of the control section 2 synthesizes the LED electric current data 25 and the image data 26, and generates the composite data signal 27 to transmit the combined data to both the backlight drive section 4 and the LCD panel 6 via the signal line 8. As a result of this, it is possible to decrease the number of the signal lines for transmitting the LED electric current data 25 and the image data 26, and to reduce the circuit area for arranging the signal lines. Thus, it is possible to work for a reduction in size and weight of the liquid crystal display unit instead of using an expensive narrow-pitch wiring board or multilayer wiring board. As a result of this, it is possible to work out for reduce in size and weight, and cost reduction of the mobile phone mounting the liquid crystal display unit.

Further, according to the first embodiment, it is possible to set the color of the white color display by both selecting the color temperature and adjusting the intensity of each color. Hence, the user can select a method for operating more easily, and set the color. Still further, it is possible to easily adjust the brightness of the display without providing a specific component for adjusting the brightness of the display.

Incidentally, the first embodiment shows the example where the LED electric current data 25 included in the composite data signal 27 is transmitted in a time-division format, using the six wirings out of the eighteen wirings constituting the signal line 8, however, the present invention is not limited thereto. For example, the LED electric current data 25 can be transmitted, using all of eighteen wirings constituting the signal line 8. In this case, the eighteen wirings are divided into six wirings each, for example, and each may be connected to the DACs 42R, 42G, and 42B of the backlight drive section 4 as shown in FIG. 8, respectively. This allows the data of each color of the LED electric current data 25 to be directly inputted to the DACs 42R, 42G, and 42B, respectively. As a result of this, it is possible to eliminate the switch section 41 and the selection signal 29.

Next, a second embodiment of the present invention will be described. The second embodiment differs from the first embodiment in the table stored in the storage section 3 (refer to FIG. 5). Table 2 shows the table stored in the storage section 3 of the liquid crystal display unit according to the second embodiment. As shown in Table 2, in the table, the color temperature is set corresponding to a region where the mobile phone is used, and the LED electric current data corresponding to each color temperature is stored therein. The configuration in the second embodiment other than explained above is similar to that of the first embodiment.

TABLE 2

| | | LED electric current data | | |
|---|---|---|---|---|
| Region | Color Temperature | R | G | B |
| . . . | . . . | . . . | . . . | . . . |
| (1) | 5500K | R1 | G1 | B1 |
| (2) | 6000K | R2 | G2 | B2 |
| (3) | 6500K | R3 | G3 | B3 |
| (4) | 7000K | R4 | G4 | B4 |
| (5) | 7500K | R5 | G5 | B5 |
| . . . | . . . | . . . | . . . | . . . |

Next, the operation and effect of the second embodiment will be described. In the actual market, there may be a case that the desired color differs depending on the region. Hence, as for the liquid crystal display unit according to the second embodiment, in a process for performing settings of the various data before products' shipment, information indicating the region to which products are shipped, for example, “region (3)” shown in Table 2, is inputted into the liquid crystal display unit. The information indicating the region is inputted into the input information processing section 21 of the control section 2 via the input section 1 shown in FIG. 5. Based on the information, the input information processing section 21 sends an instruction to the backlight control section 22. Based on the instruction, the backlight control section 22 reads the data corresponding to “region (3)”, namely, the LED electric current data 25 corresponding to the color with the color temperature of 6500 K, from the storage section 3. The subsequent operation is similar to that of the first embodiment.

As a result of this, the LED electric current data 25 set in accordance with the region becomes as default setting data, and thereafter, the white color display is performed with this color every time the power of the mobile phone is activated. This state is continued until the next color is set, for example, the user setting is performed. This makes it possible to set the color of the white color display to a color corresponding to the region at the time of shipping products, and to correspond to the user preference that differs depending on the region. Moreover, in case of changing the color by the user setting after shipment, it can be performed in a manner similar to that of the first embodiment. The operation and effect of the second embodiment other than explained above are similar to those of the first embodiment.

Incidentally, the color may be set in accordance with the region after shipping products. For example, a region where the portable device is used may be identified in cooperation with an international roaming to set a color corresponding to the region. Moreover, in case of a mobile phone mounting a GPS (Global Positioning System) device, the color may be set based on positional information obtained by the GPS device and inputted in the control section 2 as shown in FIG. 5.

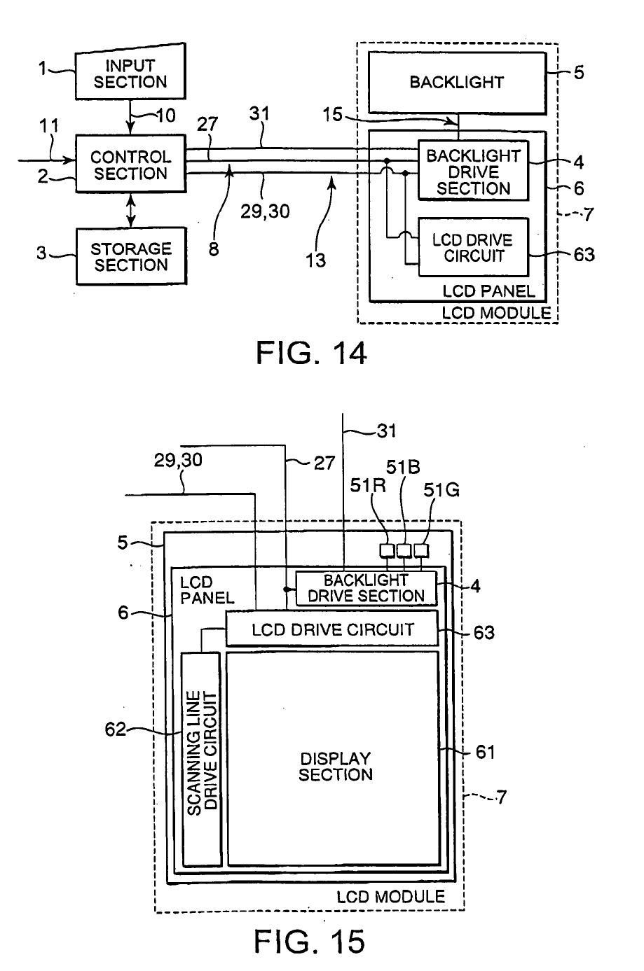

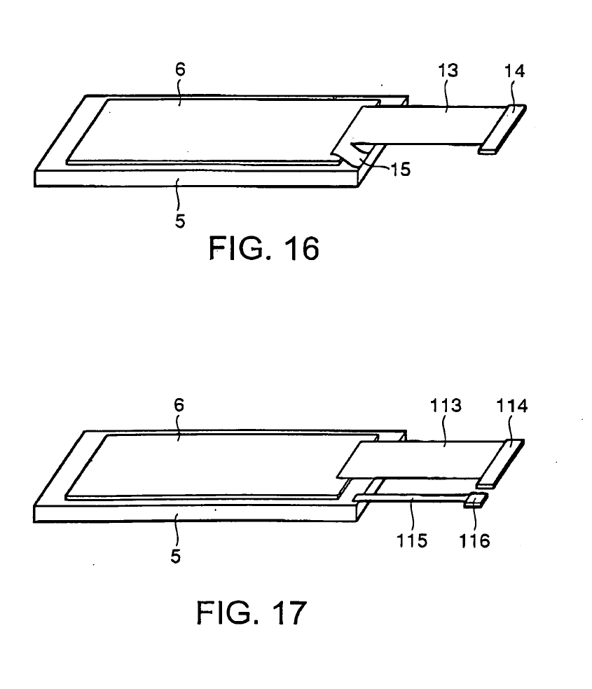

Next, a third embodiment of the present invention will be described. FIG. 14 is a block diagram illustrating a liquid crystal display unit according to the third embodiment, while FIG. 15 is a block diagram illustrating an LCD module shown in FIG. 14. FIG. 16 is a perspective view illustrating the LCD module shown in FIG. 14 and a flexible cable, while FIG. 17 is a perspective view illustrating the LCD module and the flexible cable for the purpose of comparison. Note herein that, in FIG. 14, the display section (reference numeral 61 in FIG. 9) and the scanning line drive circuit (reference numeral 62 in FIG. 9) are omitted for the purpose of simplifying the drawing.

As shown in FIGS. 14 and 15, in the liquid crystal display unit according to the third embodiment, the backlight drive section 4 is provided inside the LCD panel 6. Additionally, the selection signal (third signal) 29 outputted from the control section 2 to the backlight drive section 4 is a serial I/F signal, which is transmitted via a common flexible cable (another common signal line) 13 (refer to FIG. 16) shared with the serial I/F signal of the control signal (fourth signal) 30 outputted to the LCD panel 6 from the control section 2.

As shown in FIG. 16, in the liquid crystal display unit according to the third embodiment, the flexible cable 13 and a connector 14 are used. One end of the flexible cable 13 is connected to the LCD panel 6, while the other end is connected to the connector 14. The connector 14 is connected to the backlight control section 22 and the LCD panel control section 23 of the control section 2 as shown in FIG. 6. The backlight control section 22 transmits the selection signal 29 to the backlight drive section 4 arranged in the LCD panel 6 via the connector 14 and the flexible cable 13, while the LCD panel control section 23 transmits the control signal 30 to the LCD drive circuit 63 of the LCD panel 6 via the connector 14 and the flexible cable 13. Moreover, the control section 2 outputs a selection signal 31 to the LCD panel 6. The selection signal 31 indicates to which of the backlight drive section 4 and the LCD panel 6, the serial I/F signal transmitted via the flexible cable 13 is outputted.

Meanwhile, a flexible cable 15 is connected between the LCD panel 6 and the backlight 5. The backlight drive section 4 arranged in the LCD panel 6 provides the LEDs 51 of the backlight 5 with the electric currents through the flexible cable 15. Any connector is not connected to the flexible cable 15. Hence, only one connector (connector 14) is provided in the third embodiment. The configuration of the third embodiment other than the stated above is similar to that of the first embodiment.

In the liquid crystal display unit in FIG. 17 shown for the purpose of comparison, a flexible cable 113 is provided, one end of which is connected to the LCD panel 6, and the other end of which is connected to a connector 114. The connector 114 is connected to the LCD panel control section. Meanwhile, a flexible cable 115 is provided, one end of which is connected to the LED of the backlight 5, and the other end of which is connected to a connector 116. The connector 116 is connected to the backlight control section.

As described above, in the liquid crystal display unit shown in FIG. 17 for the purpose of comparison, the LCD panel control section and the LCD panel 6 are connected by the connector 114 and the flexible cable 113, while the backlight control section and the backlight 5 are connected by the connector 116 and the flexible cable 115. That is to say, it means that two connectors are required.

As described above, in the liquid crystal display unit in the third embodiment as shown in FIGS. 14 through 16, as compared with the liquid crystal display unit as shown in FIG. 17, the connector 116 connecting the backlight drive section 4 with the LEDs 51 may be eliminated. As a result of this, it is possible to establish reduction in size, weight, and cost of the liquid crystal display unit and that of the portable device having the same.

Moreover, in the third embodiment, the selection signal 29 transmitted from the backlight control section 22 to the backlight drive section 4 is commonized with the control signal 30 transmitted from the LCD panel control section 23 to the LCD drive circuit 63. Hence, in the third embodiment, the signal added between the backlight control section 22 and the backlight drive section 4 is only the selection signal 31 for indicating to which of the backlight drive section 4 and the LCD panel 6, the serial I/F signal that is transmitted through the flexible cable 13 is outputted. As a result of this, the number of signal lines in the conventional liquid crystal display unit is almost the same as that of the signal lines connecting between the LCD panel control section and the LCD panel. The operation and effect of the third embodiment other than the described above are similar to those of the first embodiment.

Incidentally, in the third embodiment, the backlight drive section 4 and the LCD drive circuit 63 may be comprised of the same IC (Integrated Circuit). Thus, it is possible to establish further reduction in size and cost of the liquid crystal display unit.

In addition, a connection form as shown in FIG. 16 may also be applicable to the first and second embodiments. Also in this case, the connector that has conventionally been provided for connecting between the backlight drive section 4 and the LEDs 51 can be eliminated. In this case, however, since three signal lines are added in addition to the flexible cable 13 between the backlight drive section 4 and the LEDs 51, a total number of connection lines increase more than the number in the third embodiment.

Further, in the first through third embodiments, there have been provided an exemplification in which the image data 26 and the LED electric current data 25 are commonized to thereby generate the composite data signal 27. However, the LED electric current data 25 may be formed in the serial I/F signal and commonized with the control signal 30 that is the serial I/F signal. Additionally, the signals may be used in common using a manner other than described above.

Furthermore, in the first through third embodiments, there has been provided a description of such a type of LCD module that the three-color LEDs 51 may simultaneously be lit up. However, the present invention is not limited thereto, and the three-color LEDs 51 may be sequentially lit up. This type of LCD module is referred to as a field sequential drive LED module. Namely, the field sequential drive LED module sequentially displays the RGB images on the display section 61 in synchronization with a timing of light-up of the three-color LEDs 51 and impresses the user on the color image obtained by synthesizing each of images having RGB, respectively.

Furthermore, in the first through third embodiments, there has been provided an exemplification of the mobile phone as the portable device. However, the portable device of the present invention is not limited to the mobile phone but may include, for example, a PDA (Personal Digital Assistance), a note-type personal computer, or the like.

What is claimed is:

1. A display unit comprising:
a plurality of illuminants mutually differing in luminous colors;
a drive section for driving said illuminants;
a display panel for displaying an image by being illuminated from said illuminants;
a control section for controlling said drive section and said display panel; and
a common signal line for transmitting a first signal constituting at least a part of signals that said control section outputs to said drive section, and a second signal constituting at least a part of signals that said control section outputs to said display panel.

2. The display unit according to claim 1, wherein said common signal line transmits said first signal and said second signal in a time-division format.

3. The display unit according to claim 2, wherein both said first signal and said second signal are arranged within one frame.

4. The display unit according to claim 1, wherein
said first signal is electric power data for representing the magnitude of electric power that said drive section supplies to each of said illuminants; and
said second signal is image data for representing the image displayed on said display panel.

5. The display unit according to claim 4, wherein said illuminants are light emitting diodes, said drive section supplies said light emitting diodes with an electric current, and said electric power data represents the magnitude of said electric current.

6. The display unit according to claim 1, wherein further comprises other common signal line for transmitting a third signal constituting at least a part of signals excluding said first signal out of signals that said control section outputs to said drive section and a fourth signal constituting at least a part of signals excluding said second signal out of signals that said control section outputs to said display panel.

7. The display unit according to claim 6, wherein
said third signal is a selection signal for selecting said first signal from the signals transmitted via said common signal line, and
said fourth signal is a control signal for controlling a drive circuit provided in said display panel.

8. The display unit according to claim 6, wherein said other common signal line is a flexible cable.

9. The display unit according to claim 1, wherein said drive section is arranged within said display panel.

10. The display unit according to claim 4, wherein said control section generates said first signal based on input information inputted from outside and thereby adjusts an emission intensity of said each illuminant.

11. The display unit according to claim 10, the display unit further comprising a storage section for storing said electric power data, wherein said control section reads said electric power data from said storage section based on said input information, and thereby generates said first signal.

12. The display unit according to claim 10 wherein, by adjusting said emission intensity, said control section adjusts a color of white color display of said display panel.

13. The display unit according to claim 12, wherein said input information relates to a color temperature of said white color display.

14. The display unit according to claim 12, wherein said input information relates to said emission intensity of said each illuminant.

15. The display unit according to claim 12, wherein said input information relates to information for representing a region where said display unit is used.

16. The display unit according to claim 10, wherein, by adjusting said emission intensity, said control section adjusts the brightness of said display panel.

17. The display unit according to claim 7, wherein said drive section and a drive circuit provided in said display panel are comprised of the same integrated circuit.

18. The display unit according to claim 1, wherein said display panel is a liquid crystal display panel.

19. A display unit comprising:
a plurality of illuminants mutually differing in luminous colors;
a drive section for driving said illuminants;
a display panel for displaying an image by being illuminated from said illuminants;
a control section for controlling said drive section and said display panel; and
a common signal line for transmitting a first signal which constitutes at least a part of signals that said control section outputs to said drive section and which is electric power data for representing the magnitude of electric power that said drive section supplies to each of said illuminants, and a fourth signal which constitutes at least a part of signals that said control section outputs to said display panel and which is a control signal for controlling a drive circuit provided in said display panel.

20. The display unit according to claim 19, wherein said drive section is arranged within said display panel.

21. The display unit according to claim 19, wherein said control section generates said first signal based on input information inputted from outside and thereby adjusts an emission intensity of said each illuminant.

22. The display unit according to claim 21, the display unit further comprising a storage section for storing said electric power data, wherein said control section reads said electric power data from said storage section based on said input information, and thereby generates said first signal.

23. The display unit according to claim 21, wherein, by adjusting said emission intensity, said control section adjusts a color of white color display of said display panel.

24. The display unit according to claim 23, wherein said input information relates to a color temperature of said white color display.

25. The display unit according to claim 23, wherein said input information relates to said emission intensity of said each illuminant.

26. The display unit according to claim 23, wherein said input information relates to information for representing a region where said display unit is used.

27. The display unit according to claim 21, wherein, by adjusting said emission intensity, said control section adjusts the brightness of said display panel.

28. The display unit according to claim 19, wherein said drive section and a drive circuit provided in said display panel are comprised of the same integrated circuit.

29. The display unit according to claim 19, wherein said display panel is a liquid crystal display panel.

30. A portable device comprising the display unit according to claim 1.

31. A portable device comprising the display unit according to claim 15 and a GPS device, the portable device obtaining information for representing said region through said GPS device.

32. A portable device comprising the display unit according to claim 31, the portable device obtaining information for representing said region from international roaming information.

33. A portable device comprising the display unit according to claim 19.

34. A portable device comprising the display unit according to claim 26 and a GPS device, the portable device obtaining information for representing said region through said GPS device.

35. A portable device comprising the display unit according to claim 34, the portable device obtaining information for representing said region from international roaming information.
